(19) United States
(12) Patent Application Publication
(10) Pub. No.: US 2010/0030925 A1
(43) Pub. Date: Feb. 4, 2010

(54) PRINTER AND CONTROL METHOD THEREOF

(75) Inventor: Yoshimasa Inoue, Shizuoka (JP)

Correspondence Address: TUROCY & WATSON, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/400,046

(22) Filed: Mar. 9, 2009

(30) Foreign Application Priority Data
Jul. 31, 2008 (JP) 2008-197798

(51) Int. Cl. G06F 3/00

(52) U.S. Cl. 710/16

(57) ABSTRACT

A printer includes: a USB connector that is detachably connected to a USB interface forming a data communication channel through which data can be exchanged between the printer and an external device; a second connector that is constantly connected to a second interface that is provided independently of the USB interface and forms a data communication channel through which data can be exchanged between the printer and the external device; a USB connection detection section that detects whether the USB interface is connected to the USB connector; a signal channel selection section that receives a switch control signal from the USB connection detection section and switches a data communication channel from the data communication channel using the second interface through which data is exchanged between the printer and external device to a data communication channel using the USB interface; a signal conversion section that is provided between the signal channel selection section and second connector and coverts USB data signal into a data signal for the second interface and vice versa; and a USB controller that controls USB connection.

### CROSS-REFERENCE TO RELATED APPLICATIONS

This application is based upon and claims the benefit of priority from the prior Japanese Patent Application No. 2008-197798, filed on Jul. 31, 2008, the entire contents of which are incorporated herein by reference.

### BACKGROUND OF THE INVENTION

1. Field of the Invention

The present invention relates to a printer that exchanges data with a host computer serving as an external device through data exchange channels of a plurality of different interfaces and a control method thereof.

2. Description of the Related Art

Conventionally, there is available a printer that is connected, using a plurality of interfaces (hereinafter, abbreviated as “I/F”) corresponding to a plurality of data exchange channels, to a host computer serving as an external device with which the printer exchanges data.

When viewed from a point of view of a data exchange means, there is known a printer that is provided with both a wired data exchange means that communicates with a host computer using a communication cable and an infrared ray data exchange means that communicates with a host computer through an infrared ray.

In a printer that is provided with two different data exchange means, in the case where a user selects one of the data exchange means for use in accordance with the connection environment of the host computer to be connected, he previously performs setting by using a DIP switch (setting switch) provided to the printer so as to activate one of the data exchange means based on information set by the DIP switch. As another example, known is a configuration in which switching between communication channels and communication means in the printer is automatically made based on whether an input communication switching signal is High level or Low level (refer to, e.g., Jpn. Pat. Appln. Laid-Open Publication No. 2000-158747).

When viewed from a point of view of a data transmission method, a printer provided with a plurality of I/Fs has I/Fs corresponding to a plurality of buses. The I/Fs mentioned are, e.g., Ethernet®, USB (Universal Serial Bus), and IEEE1394.

In this case, a user selects, from the plurality of I/Fs, a desired I/F based on the use state of the printer, and the print data from application software is transferred through a printer driver (refer to, e.g., Jpn. Pat. Appln. Laid-Open Publication No. 2003-076649).

Generally, in a printer that is provided with a plurality of I/Fs, a user manually selects an I/F to be used after the printer enters a set-up mode on each occasion.

In a printer provided with a plurality of I/Fs corresponding to a plurality of data transfer channels, in order to validate the content of user setting in a set-up mode that executes selection of a character generator to be used, the printer needs to be rebooted every time the I/F to be used is switched, thereby providing a user with troublesome work and causing errors in association with the troublesome work.

### BRIEF SUMMARY OF THE INVENTION

It is an object of the present invention to provide a printer provided with a plurality of I/Fs, including USB, corresponding to a plurality of data transfer communication and capable of automatically switching between the plurality of I/Fs by detecting the connection of a USB cable.

In an aspect of the present invention, a printer includes: a USB connector that is detachably connected to a USB interface forming a data communication channel through which data can be exchanged between the printer and an external device; a second connector that is constantly connected to a second interface that is provided independently of the USB interface and forms a data communication channel through which data can be exchanged between the printer and the external device; a USB connection detection section that detects whether the USB interface is connected to the USB connector; a signal channel selection section that receives a switch control signal from the USB connection detection section and switches a data communication channel from the data communication channel using the second interface through which data is exchanged between the printer and external device to a data communication channel using the USB interface; a signal conversion section that is provided between the signal channel selection section and second connector and coverts USB data signal into a data signal for the second interface and vice versa; and a USB controller that controls USB connection.

### BRIEF DESCRIPTION OF THE DRAWINGS

FIG. 1 is a block diagram for explaining a printer and a control method thereof, which shows functions of a controller and a data communication section of the printer;

FIG. 2 is a flowchart showing operation of I/F switch control in the present invention; and

FIG. 3 is a flowchart showing operation of I/F switch control in the present invention.

### DETAILED DESCRIPTION OF THE INVENTION

Throughout this description, the embodiments and examples shown should be considered as exemplars, rather than limitations on the apparatus and methods of the present invention.

A preferred embodiment for practicing a printer and a control method thereof will be described below with reference to the accompanying drawings.

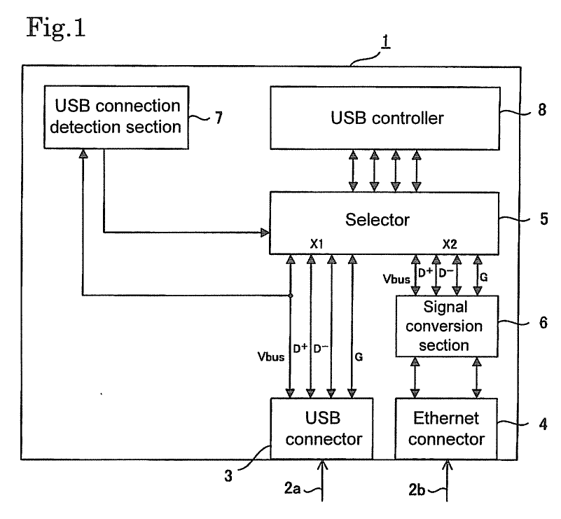

FIG. 1 is a block diagram for explaining a printer and a control method thereof, which shows functions of a controller and a communication section of the printer. The present embodiment focuses on a data communication channel between a printer and a host computer and does not relate directly to a printing method of the printer or configuration of a printing section of the printer. That is, the printing method may be an impact method (wire-dot method, etc.) or non-impact method (ink-jet method, etc.). Further, a known configuration may be applied to the printing section irrelevant of the printing method employed. Thus, a description of a configuration of the printing section and the like of the printer is omitted.

A control/communication section 1 of the printer roughly includes a USB connector 3, an Ethernet connector 4, a selector 5 that selects a signal channel, a signal conversion section 6, a USB connection detection section 7, and a USB controller 8.

The control/communication section 1 of the printer is connected to a host computer (not shown) which is an external device with which the printer exchanges data through communication cables 2a and 2b. One USB connector 3 and one Ethernet connector 4 (second connector) are provided in the control/communication section 1.

The communication cable 2b connected to the Ethernet connector 4 is an Ethernet cable. The Ethernet cable 2b is a bus type interface and is constantly connected to the printer through the Ethernet connector 4. Thus, data communication state through a LAN between the host computer and the control/communication section 1 of the printer is always established.

On the other hand, the USB connector 3 provided in the control/communication section 1 is a four-pin USB connector compliant with USB specification. According to USB specification, signals of Vbus, D+, D−, and GND are assigned to the four pins of the USB connector 3, respectively. It goes without saying that one or more USB connector 3 may be provided.

Vbus is used as a line for supplying power to the selector IC 5 or USB controller 8 that is activated by a USB signal, and the ground level thereof is GND. D+ and D− are lines for exchanging data on USB data communication. The D+ and D− each function as a differential signal having an amplitude of 3.3 V in FS mode and 400 mV in HS mode.

In USB specification, there exist three data transfer rates: 1.5 Mbps, 12 Mbps, and 480 Mbps, which are referred to as LS mode, FS mode, and HS mode, respectively. According to the USB specification, D− is pulled up in LS mode, and D+ is pulled up in FS and HS modes.

An output signal from the USB connector is input to the selector 5 as an X1 signal. An output signal from the Ethernet connector 4 is input to the signal conversion section 6. The input Ethernet signal is then converted into a USB signal by the signal conversion section 6, followed by assignation of signals of Vbus, D+, D−, and GND to the USB signal. Then, the USB signal is input to the selector 5 as an X2 signal.

The signal conversion section 6 is a bi-directional signal device and is configured to convert an Ethernet signal into an USB signal and, conversely, in the case where information on the printer side needs to be transmitted to the host computer, convert an USB signal into an Ethernet signal. Thus, the signal conversion section 6 has a function of converting a signal into a signal conforming to a predetermined protocol.

The Vbus signal which is one of the USB signals output from the USB connector 3 is input to an IO port of the USB connection detection section 7. The USB connection detection section 7 detects whether the USB cable is connected to the USB connector 3. More specifically, when the host computer and the control/communication section 1 are connected to each other by the USB communication cable 2a, the USB connection detection section 7 detects a change in the potential of Vbus. That is, the USB connection detection section 7 detects a change in the potential of Vbus to thereby determine whether the USB cable is connected to the USB connector 3.

Note that a USB device has a plug-and-play (PnP) function of automatically starting system configuration upon connection of the USB cable 2a to the USB connector 3, thereby eliminating the need for a user to perform setting of the host in accordance with its peripheral device or restart the host.

That is, when the host computer which is a host device and the control/communication section 1 of the printer which is a USB device are connected to each other, USB data is exchanged between USB terminals. At this time, the type of the USB device is recognized, and a driver corresponding to the recognized USB device type is loaded, whereby a system performing the USB data communication is established. After that, data communication is repeated as needed between the host device (host computer) and USB device (control/communication section 1 of the printer) as long as the data communication state is established.

That is, by the operation that connects the USB cable 2a to the USB connector 3, the plug-and-play operation is started and, whereby, the device is recognized. A set of protocols required at this time are defined by USB specification.

The USB connection detection section 7 can be constituted by an ASIC (Application Specific Integrated Circuit). In this case, various control circuits are formed. Although not shown, examples of the various control circuits include an interruption control circuit for controlling various interruption processing, an encoder processing circuit for controlling an encoder that detects the position of a recording head (in the case of a printer of a type in which the recording head is moved), a bus control/DMA controller for controlling data transfer using DMA (Direct Memory Access), a motor control circuit for controlling drive of a motor for driving a paper feeding roller, an I/F control circuit for controlling a USB I/F connecting a computer with a peripheral device, a power control circuit for controlling a plurality of types of power supplies such as an AC power supply and USB power supply, and the like.

An output signal from the IO port of the USB connection detection section 7 is input to the selector 5 as a selector switch control signal, whereby information on whether the USB cable is connected to the USB connector 3 is transmitted to the selector 5. Upon reception of the selector switch control signal, the selector 5 performs switching between the X1 signal output from the USB connector 3 and the X2 signal which is a USB signal that has been converted from an Ethernet signal.

An output signal from the selector 5 is input to the USB controller 8. The USB controller 8 controls the host computer which is the USB host and the control/communication section 1 of the printer which is the USB device to control/process transmission/reception of a data communication signal according to a USB protocol.

The USB controller 8 has a DIR terminal for a transmission/reception switch signal, a D+ terminal, and a D− terminal, as well as a Vbus terminal and a GND terminal. The USB controller 8 transmits/receives the USB data communication signal through the D+ terminal and D− terminal.

Further, the USB controller 8 analyzes the USB data communication signal received through the D+ terminal and D− terminal to generate a control signal indicating the transmission direction of the USB data communication signal and, based on the generated control signal, controls the voltage of the DIR terminal.

Note that FIG. 1 is a functional block diagram and therefore the respective sections are shown in an independent manner. Actually, however, the selector 5 or the signal conversion section 6 may be incorporated in the printer or may be externally provided to the printer. Further, the USB connection detection section 7, selector 5, and USB controller 8 may be mounted in one package.

Further, although Ethernet is used for LAN data communication in the above case, IEEE 1394 and the like may be used.

Next, the I/F switch control in the control/communication section 1 of the printer having the above configuration will be described.

First, a state where the USB cable 2a is connected to the USB connector 3 of the control/communication section 1 will be described.

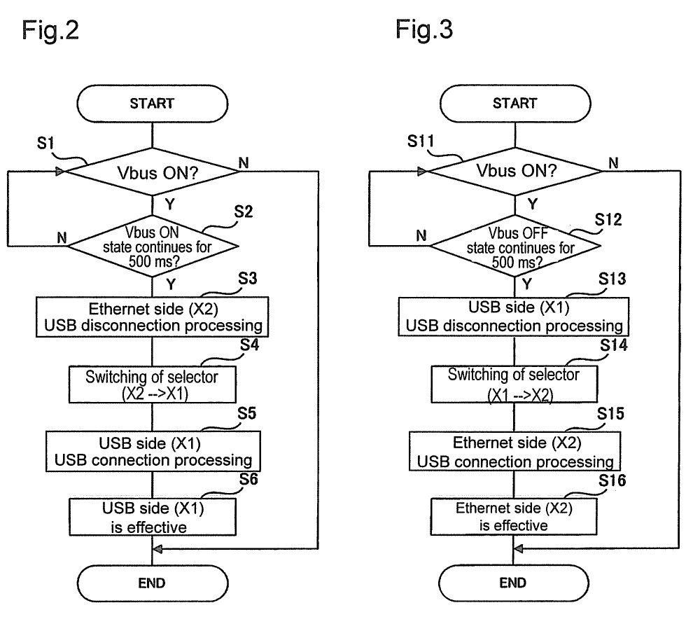

FIG. 2 is a flowchart showing a state where the USB cable 2a is connected to the USB connector 3 of the control/communication section 1.

It is determined at the IO port of the USB connection detection section 7 “whether Vbus, which is one of the output signals from the USB connector 3, is ON” (step S1: connection determination step).

When it is determined that “Vbus is ON”, it is determined “whether ON state continues for 500 ms” (step S2: connection time determination step).

When it is determined in step S1 that “Vbus is OFF”, the flow is ended.

When it is determined by the USB connection detection section 7 that “ON state continues for 500 ms”, “selector switch control signal” is transmitted from the USB connection detection section 7 to the selector 5. Then, the selector 5 performs “disconnection processing of USB signal from Ethernet side (X2)”. (step S3: switching step).

When it is determined that “ON state does not continue for 500 ms”, the flow returns to step S1.

Then, the selector 5 switches connection “from Ethernet side (X2) to USB side (X1)” (step S4: switching step).

Subsequently, USB connection processing to the USB side (X1) is performed (step S5).

As a result, the USB side (X1) is effective, and data communication state through the USB side (X1) is established (step S6).

Next, a state where the USB cable 2a is not connected to the USB connector 3 of the control/communication section 1 will be described.

FIG. 3 is a flowchart showing a state where the USB cable 2a is not connected to the USB connector 3 of the control/communication section 1.

It is determined by the USB connection detection section 7 “whether Vbus, which is one of the output signals from the USB connector 3, is OFF” (step S11: connection determination step).

When it is determined that “Vbus is OFF”, it is determined “whether OFF state continues for 500 ms” (step S12: disconnection time determination step).

When it is determined in step S11 that “Vbus is ON”, the flow is ended.

When it is determined by the USB connection detection section 7 that “OFF state continues for 500 ms”, “selector switch control signal” is transmitted from the USB connection detection section 7 to the selector 5. Then, the selector 5 performs “disconnection processing of USB signal from USB side (X1)” (step S13).

When it is determined that “OFF state does not continue for 500 ms”, the flow returns to step S11.

Then, the selector 5 switches connection “from USB side (X1) to Ethernet side (X2)” (step S14: switching step).

Subsequently, USB connection processing to the Ethernet side (X2) is performed (step S15).

As a result, the Ethernet side (X2) is effective, and data communication state through the Ethernet side (X2) is established (step S16).

With the above processing steps, the printer having a plurality of I/Fs including a USB corresponding to a plurality of data communication channels detects the connection of the USB cable and thereby automatically switching between the plurality of I/Fs.

According to the present embodiment, it is possible to eliminate for an operator to perform additional setup work of a printer or restart of a printer. Thus, errors due to the additional setup work can be avoided.

The present invention is not limited to the above embodiment but various modifications can be made within the scope of the present invention. Further, various inventions can be formed by appropriately combining a plurality of required constituent elements disclosed in the embodiment. For example, some required constituent elements may be omitted from all required constituent elements disclosed in the embodiment. Furthermore, required constituent elements across different embodiments may be appropriately combined.

What is claimed is:

1. A printer comprising:
a USB connector that is detachably connected to a USB interface forming a data communication channel through which data can be exchanged between the printer and an external device;
a second connector that is constantly connected to a second interface that is provided independently of the USB interface and forms a data communication channel through which data can be exchanged between the printer and the external device;
a USB connection detection section that detects whether the USB interface is connected to the USB connector;
a signal channel selection section that receives a switch control signal from the USB connection detection section and switches a data communication channel from the data communication channel using the second interface through which data is exchanged between the printer and external device to a data communication channel using the USB interface;
a signal conversion section that is provided between the signal channel selection section and the second connector and coverts USB data signal into a data signal for the second interface and vice versa; and
a USB controller that controls USB connection.

2. The printer according to claim 1, wherein the second interface is Ethernet®, and the second connector is an Ethernet connector.

3. The printer according to claim 1, wherein one or more USB connecters are provided in the printer.

4. The printer according to claim 1, wherein at least three USB connectors are provided-in the printer.

5. The printer according to claim 1, wherein the signal channel selection section is externally provided to the printer.

6. The printer according to claim 1, wherein the signal conversion section is externally provided to the printer.

7. The printer according to claim 1, wherein the second connector is externally provided to the printer.

8. The printer according to claim 1, wherein the signal channel selection section and the signal conversion section are externally provided to the printer.

9. The printer according to claim 1, wherein
the signal channel selection section and the second connector are externally provided to the printer.

10. The printer according to claim 1, wherein the signal conversion section and the second connector are externally provided to the printer.

11. The printer according to claim 1, wherein the signal channel selection section, the signal conversion section, and the second connector are externally provided to the printer.

12. The printer according to claim 1, wherein the USB connection detection section is constituted by an ASIC (Application Specific Integrated Circuit).

13. The printer according to claim 1, wherein the USB connection detection section detects a connection state of the USB interface based on the potential of Vbus which is one of signals output from the USB connector.

14. A printer control method comprising:
a connection determination step of determining whether a USB interface forming a data communication channel through which data can be exchanged between the printer and an external device is connected to a USB connector based on the potential of Vbus which is one of signals output from the USB connector;
a connection time determination step of determining, in the case where it has been determined in the connection determination step that the USB interface is connected to the USB connector, that the connection state continues for a predetermined time period; and
a switching step of switching, in the case where it has been determined in the connection time determination step that the connection state continues for a predetermined time period, a data communication channel so that data communication is established using the USB interface.

15. The printer control method according to claim 14, wherein
in the case where it has been determined in the connection time determination step that a disconnection state between the USB interface and USB connector continues for a predetermined time period, the switching step switches a data communication channel so that data communication is established using an interface other than the USB interface.

16. The printer control method according to claim 14, wherein
the predetermined time period is 500 ms.
